(19) United States
(12) Patent Application Publication
(10) Pub. No.: US 2005/0198886 A1
(43) Pub. Date: Sep. 15, 2005

(54) Fish gripper

(76) Inventor: Marietta Viduya Rojas, Los Angeles, CA (US)

Correspondence Address: MARIETTA V. ROJAS, APT. #205, 859 S. NEW HAMPSHIRE AVE., LOS ANGELES, CA, 90005, US

(21) Appl. No.: 11/062,334

(22) Filed: Feb. 22, 2005

Related U.S. Application Data
(60) Provisional application No. 60/551,248, filed on Mar. 9, 2004.

(51) Int. Cl. A01K 97/00; A01K 77/00

(52) U.S. Cl. 43/4; 43/5

(57) ABSTRACT

This device is intended to make fishing activity easier. Since fishing mechanisms have been improved from pre-fishing such as baits, fishing outfits to fishing period such as hooks and rods, this device is intended to be used during the post-fishing or after the fish has been caught. The common predicament after the fish has been caught is how to easily get the fish off the hook without hurting oneself or losing the catch. As the fish is caught, it secretes a slippery liquid to free itself from the handgrip. This practice leads to a difficult and a messy catch. The Fish Gripper is then devised to come up with a firm grip to assure that the fish doesn't slip out of a bare hand clutch.

### BRIEF SUMMARY OF THE INVENTION

Fishermen have adapted various methods of securing and unhooking a caught fish. Some use fishnets and some simply wait the fish until it runs out of breath. They secure the caught fish inside the net, and then the unhooking occurs either with bare hands or with gloves to protect one's hands. With this manner, the issue of slippery caused by the liquid secretion still makes the unhooking process complicated. The other practice, waiting for the fish's breath to run out, aside from it's time consuming nature, still faces difficult handling due to the slippery attribute of the fish.

The Fish Gripper addresses this problem by providing a secure grip on the fish through the use of a rough and jagged material. The rough material tends to create friction into the scales and holds it into place despite the liquid secretion. The fish gripper also protects the hand from the fish's sudden movement that may cause injury. With the fish secured in one hand, it is easier to detach the hook; hence faster and more convenient unhooking is achieved.

### BRIEF DESCRIPTION OF THE SEVERAL VIEWS OF DRAWING

FIG. 1 Top View

FIG. 2. A Bottom View

FIG. 2. B Side View

FIG. 3. Isometric View

### DETAILED DESCRIPTION OF THE INVENTION

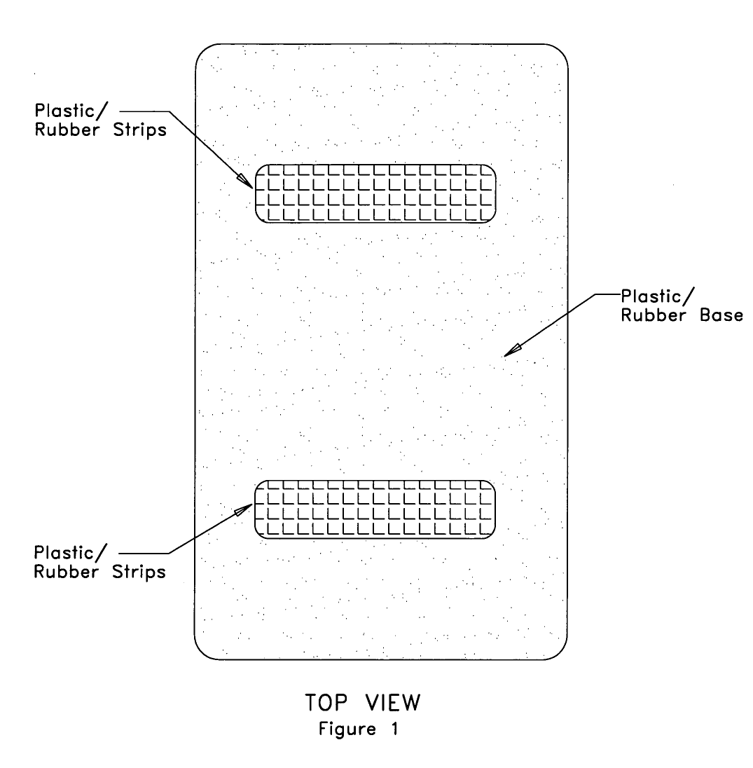

The top view (FIG. 1) will show us that it has two rubber strips attached to a plastic/rubber base. These rubber strips are provided to hold the hands in place. The 1^{st} rubber strip is used to put the thumb, while the 2^{nd} rubber strip is used to put the rest of the fingers.

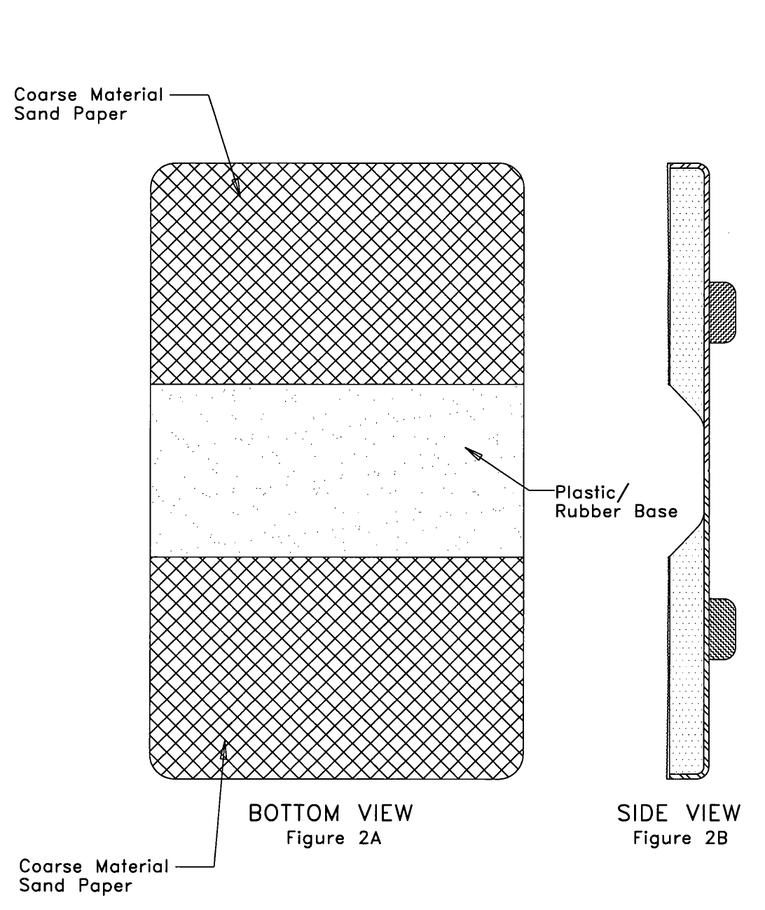

The bottom view/side view set-up (FIGS. 2a & 2b) explains that the rubber/plastic bars contain the coarse material (sand paper). The coarse material (sand paper) is glued/attached to the bars. The coarse material is used to hold the fish in place.

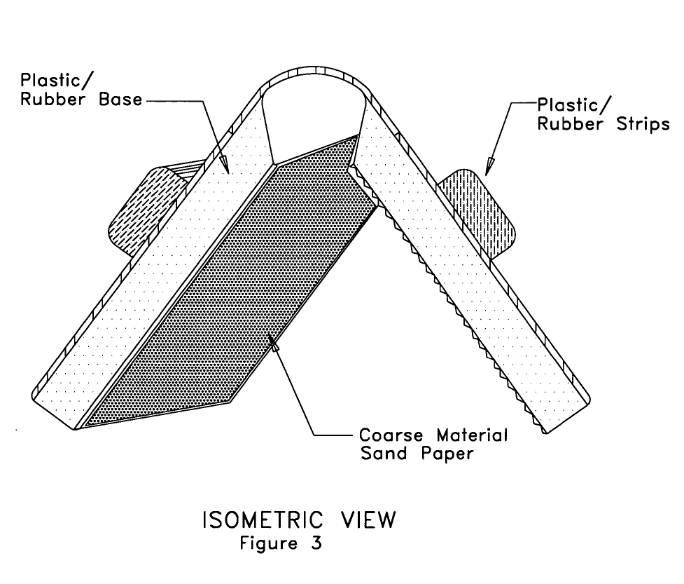

In the isometric view (FIG. 3), one would notice that the plastic/rubber base holds two thick plastic/rubber bars. These rubber bars are placed at both ends of the plastic/rubber base. With the rubber bars at both ends, this exposes the plastic/rubber base in the middle. This is to provide control and further maneuvering of the gripper since the gripper sits exactly on the C-shaped hand as the fingers are tightly placed on the rubber strips.

1. A coarse material is to be used to hold and detach a fish from a hook and to protect one's hand.
